(19) United States
(12) Patent Application Publication
(10) Pub. No.: US 2010/0314165 A1
(43) Pub. Date: Dec. 16, 2010

(54) LINE SET MADE OF PLASTIC MATERIAL

(76) Inventor: Gerald Kammer, Ludwigsburg (DE)

Correspondence Address: KENYON & KENYON LLP, ONE BROADWAY, NEW YORK, NY, 10004, US

(21) Appl. No.: 12/797,264

(22) Filed: Jun. 9, 2010

(30) Foreign Application Priority Data
Jun. 10, 2009 (DE) 102009026873.1

(51) Int. Cl. H02G 3/00; B29C 45/14

(52) U.S. Cl. 174/70 R; 264/242; 425/577

(57) ABSTRACT

A line set having a plastic body made of plastic material for contacting a sensor and to a method for manufacturing a line set of this type. The plastic body includes at least one flexible, elastic area like a film hinge. At least one cable is embedded plane-parallel in the plastic body over its length.

### CROSS REFERENCE

The present application claims the benefit under 35 U.S.C. §119 of German Patent Application No. 102009026873.1 filed on Jun. 10, 2009, which is expressly incorporated herein by reference in its entirety.

### BACKGROUND INFORMATION

The compact construction of new generations of transmissions for vehicles, in particular automatic transmissions, is accompanied by the circumstance that less and less installation space is available for the installation of a transmission control unit and its interface assemblies, such as sensors and actuators.

In older generations of transmissions, interface assemblies are attached to large plastic parts, in general to carrier plates, and pressed therein, for example, and may thus be positioned in the correct location directly in the manual transmission. The correct spacing with respect to individual functional components, such as gear wheels, is set and secured during the installation via various screw connection locations, which are provided on the transmission housing.

In newer generations of transmissions, sensors are incorporated via a compact line set in the transmission housing due to the increasingly scarce available space in the transmission housing. This line set includes one or more extrusion-coated line cables, which are electrically connected to a speed sensor on the one side, for example, and are electrically contacted with a stamped grid, for example, on the other side. The required flexibility for the positioning during the installation procedure in the transmission housing is generally currently achieved via film hinges, which are provided in the line set. The attachment to the sensor on the transmission housing, for example, is performed via a screw connection.

An older generation of transmission control module is depicted by the illustration in FIG. 1. It includes a speed sensor, which is permanently pressed into the carrier plate so that it is permanently secured in the transmission control module in relation to the signal-emitting gear wheel to be detected. The transmission control module behind the control unit is permanently screwed and thus secured in the installation location via screw connections in the transmission housing at the customer site.

The illustration in FIG. 2 shows a detail of a newer generation of transmission control module. In comparison to the older generation of transmission control module in FIG. 1, the newer transmission control module according to the illustration in FIG. 2 includes flexible attachment of a speed sensor. In the illustration in FIG. 2, the “park” position of the speed sensor is shown, whereby the position of the speed sensor before its final installation is understood. The line set preferably includes two line cables embedded in plastic, which must be bent via film hinges in this application in the range from ±90°<×<180° for the corresponding transmission embodiments. The securing in the transmission housing is performed during the final installation via the screw connection, as shown in FIG. 2.

### SUMMARY

According to an approach according to an example embodiment of the present invention, the functionality is ensured via film hinges. These ensure breakage-free installation of the line set in the transmission, without function-impairing aging of the plastic material due to contact with the transmission fluid being a concern. The film hinges are also able to be removed repeatedly in a nondestructive manner after long operation, during which the film hinges come into contact with the aggressive, low-viscosity medium of automatic transmission fluid (ATF), which encourages aging of the plastic material.

According to the example approach according to the present invention, plane-parallel embedding of the line cables is performed over a total sub-length of the line set cross section with the aid of corresponding openings, which are provided in a molded part. Contouring stamps in the injection-molding tool secure the cables in these openings under the influence of the injection pressure prevailing in the injection-molding tool and hold them in position.

The advantages accompanying the example approach according to the present invention may be seen in that flawed, and thus damage-causing, placing of the cable or cables in the injection-molding tool is avoided. This makes it possible to reduce the reject rate. This applies, on the one hand, for the pre-installation in the “park” position and, on the other hand, during the final installation of the line set with the control unit in the transmission at the customer site.

The example approach according to the present invention fulfills the customer requirements for vibration resistance. This means that breaking does not occur during operation of the line set. Furthermore, it is ensured by the example approach proposed according to the present invention that nondestructive removability is provided, so that repairs may certainly be performed, premature aging of the plastic material due to contact with the low-viscosity aggressive transmission fluid (ATF) in the automatic transmission of a vehicle being taken into consideration.

According to the example approach according to the present invention for providing a line set which fulfills these requirements, one or more cables having plastic insulation, which is preferably manufactured from a material such as PTFE, are secured using a plastic extrusion coating. The plastic extrusion coating has flexible, bendable areas, which are required for installation or also during removal in case of damage in a motor vehicle transmission, preferably an automatic transmission. It is of particular significance in this context that the cables are secured in the injection-molding tool in such a way that they may be enclosed plane-parallel and thus without being damaged by the injected plastic. No pinching or stripping of the installation by the injection-molding tool occurs as a result of “floating” of the cables in the lateral direction in the case of high injection pressure. The cables, which are preferably two cables running parallel to one another, are held on both sides in the injection-molding tool using specially designed, rounded tool stamps. Specially designed tool cores, which are also rounded, are incorporated in the two stamps of the tool and stably stretch the cables, which are preferably two cables running parallel to one another, with their entire cross section over the outside surface at a specific ratio in the tool, so that they are unchangeable under consideration of the injection pressure prevailing in the injection-molding tool, i.e., they maintain their original inserted position even during the injection of the plastic material and the high injection pressure thus prevailing during the molding process.

### BRIEF DESCRIPTION OF THE DRAWINGS

The present invention is described in greater detail below based on the figures.

FIG. 1 shows a schematic illustration of an older, conventional transmission control module side.

FIG. 2 shows a newer possible conventional embodiment of a transmission control module having a line set for contacting a sensor on the outer side of the transmission housing.

FIG. 3 shows a top view of a plastic body made of plastic material of a line set according to an example embodiment of the present invention.

FIG. 4 shows section line IV-IV shown in FIG. 3 with implementation of a contact zone.

FIG. 5 shows section line V-V in FIG. 3 with implementation of two contact zones on the two tool halves of the injection-molding tool.

FIG. 6 shows section line VI-VI shown in FIG. 3 with the outside cores retracted into the upper tool half.

FIG. 7 shows a top view of a further embodiment variant of the line set proposed according to the present invention having widened tool cores.

FIG. 8 shows an illustration of section line VIII-VIII according to FIG. 7 having cores implemented on both tool halves.

FIG. 9 shows the embedding of two plane-parallel cables and an enlarged view of the height ratio x:y in relation to the embedding of the cable diameter in the case of a tool partition situated off-center.

FIG. 10 shows an embodiment variant of an off-center tool partition having recesses.

### DETAILED DESCRIPTION OF EXAMPLE EMBODIMENTS

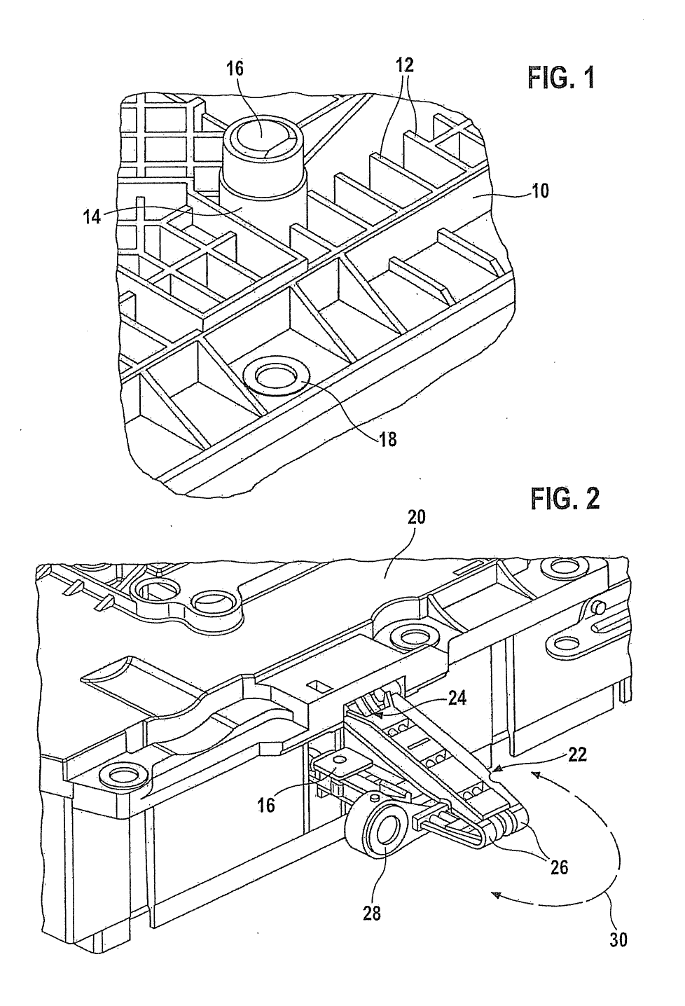

FIG. 1 shows a schematic view of an embodiment variant of an older conventional transmission module. The illustration according to FIG. 1 shows that a plastic structure 10, which represents a transmission housing, is provided with a ribbing 12. Domed protrusions 14, into which a speed sensor 16 may be pressed, for example, are in turn implemented in ribbing 12. Plastic structure 10 may in turn be connected at screw connection locations 18 to the vehicle chassis.

A newer conventional transmission module concept is shown in the illustration according to FIG. 2.

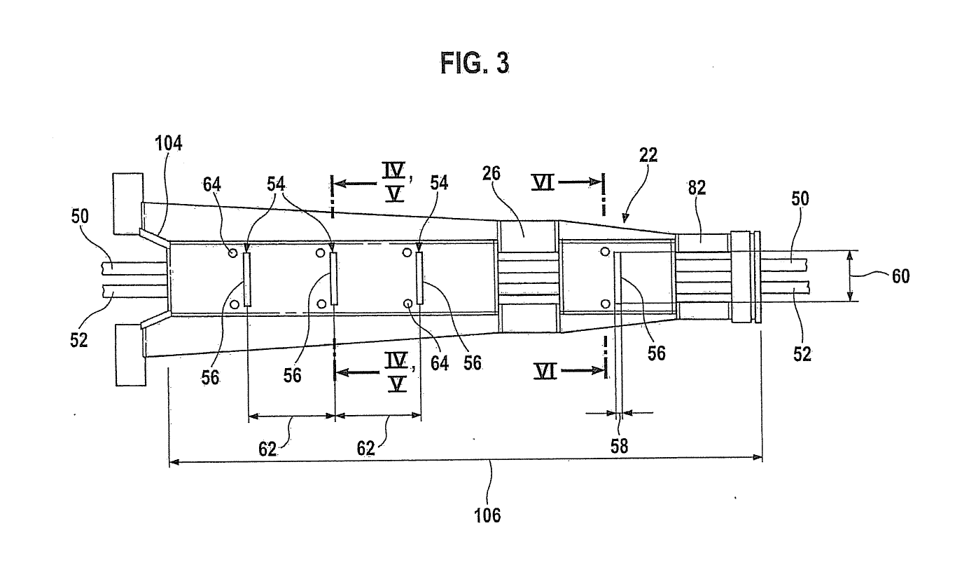

In this embodiment variant, a line set 22 for contacting speed sensor 16 is attached laterally to a transmission control module 20. Speed sensor 16 is contacted at one end of line set 22, and line set 22 is electrically connected to a stamped grid or contact grid (not shown) at the other end according to the illustration in FIG. 2. Line set 22 includes two line cables 24 running parallel to one another in the embodiment variant according to FIG. 2. A film hinge 26 is located in line set 22 at the location of a maximum deflection 30. A screw connection 28 is used for attachment. Line set 22 is deflected in a bending range from ±90°<×<180° at the location of maximum deflection 30. The embodiment variants shown in FIGS. 1 and 2 represent contact possibilities of speed sensors 16. A first example embodiment variant of a line set proposed according to the present invention is shown in the illustration according to FIG. 3.

FIG. 3 shows that line set 22 proposed according to the present invention preferably includes two extrusion-coated cables 50 and 52. Both cables 50 and 52 run plane-parallel within line set 22. Instead of two cables 50 and 52, as shown in FIG. 2, the line set may also include only one cable or may also have more than two cables, which are situated plane-parallel to one another.

The top view shown in FIG. 3 shows that the line set proposed according to an example embodiment of the present invention is generally a plastic body 104 produced in an injection-molding tool. In this embodiment variant, two cables 50 and 52 laid plane-parallel in the cavity of the injection-molding tool are extrusion coated in this plastic body 104, which extends in the plane of the drawing according to FIG. 3. Both cables 50 and 52 are embedded in plastic material 70 of plastic body 104 with a length 106, which generally corresponds to the length of plastic body 104.

FIG. 3 shows that plastic body 104 of line set 22 has support areas 54 spaced apart from one another in a grid 62. These are rounded tool cores, which are implemented on the sides of tool halves 66 and 68 of the injection-molding tool, which delimit the cavity into which plastic material 70 is injected, from which plastic body 104 is injection-molded.

Support areas 54, which may be implemented on a side of a first tool half 66 or a second tool half 68 facing toward the cavity, run in a first width 58. First width 58 generally overlaps both cables 50 and 52 extending through line set 22. Reference numeral 60 identifies a length in which individual cores 56 are implemented in tool halves 66 and 68.

In addition, at least one film hinge 26 is located in plastic body 104 of line set 22 according to the illustration in FIG. 3. In the embodiment variant shown in FIG. 3, a film hinge 26 and a further film hinge 82 are implemented on plastic body 104. Film hinges 26 and 82 represent flexible, bendable areas of plastic body 104, which are required for the installation on or possibly, in case of damage, for the removal from an automatic transmission of a vehicle. Repeated nondestructive removal after operation of the line set and aging of the plastic material, which accompanies an aggressive fluid, such as transmission fluid ATF, is able to be ensured by flexible and bendable film hinges 26 and 82.

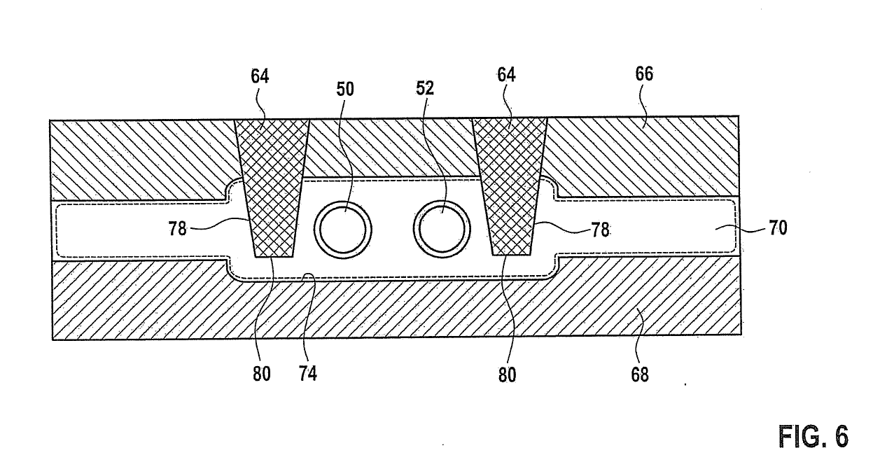

Furthermore, the top view according to FIG. 3 of the line set shows that lateral cores 64 are also provided in a grid which is offset to grid 62 of cores 56. Using lateral cores 64, which retract into the cavity of the injection-molding tool through corresponding openings in one of tool halves 66 and 68, both cables 50 and 52 generally remain in their plane-parallel position and cables 50 and 52 do not float laterally under the effect of the injection pressure. By using lateral cores 64 (cf. also FIG. 6), it is ensured that insulation 86 of first cable 50 or second cable 52 do not migrate impermissibly far within the cavity as soon as they are subjected to the injection pressure of liquid plastic material 70 shooting into the cavity.

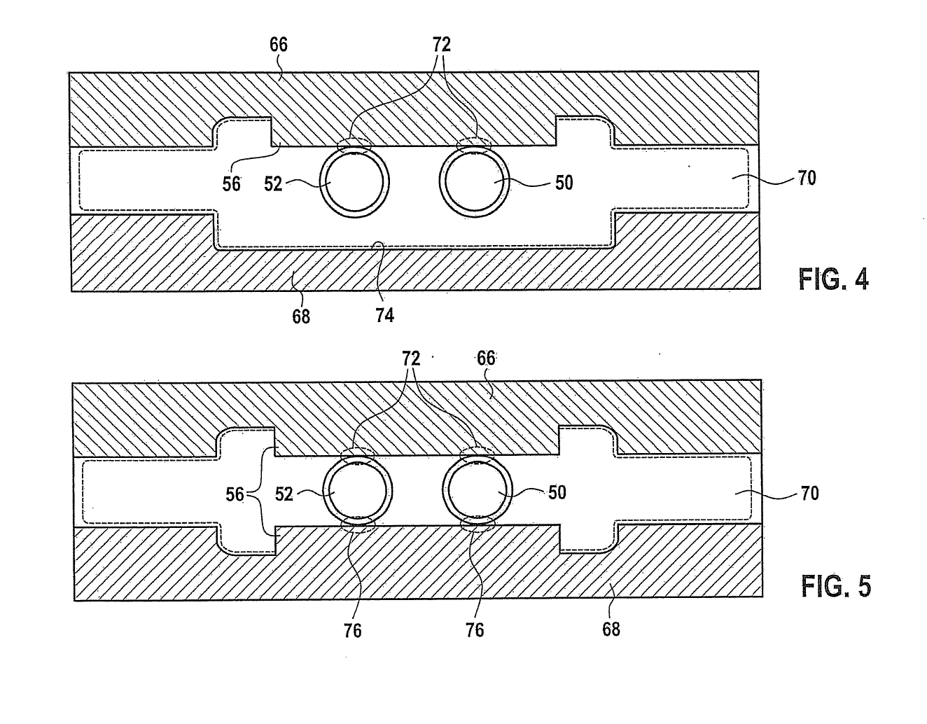

Both cables 50 and 52, which are shown plane-parallel here, are advantageously enclosed by the plastic material along length 106 of plastic body 104, the plastic material only being reduced in regard to its thickness in the area of film hinges 26 and 82. The illustration according to FIG. 4 relates to section line IV-IV in FIG. 3.

The illustration of FIG. 4 shows that both cables 50 and 52, which are laid in the cavity of the injection-molding tool and are situated parallel to one another, are embedded in the cavity of the injection-molding tool in plastic material 70 upon its injection into the cavity. Both cables 50 and 52 are held down by core 56, which is implemented in this case on first tool half 66; a first contact zone 72 is formed between the outside surfaces of first cable 50 and second cable 52. A recess 74 is introduced in second tool half 68, which forms the cavity with first tool half 66, diametrically opposite first contact zone 72.

FIG. 5 shows section line V-V in FIG. 3.

The illustration of FIG. 5 shows that a rounded core 56 runs both on the side of first tool half 66 facing toward the cavity and on second tool half 68 according to section line V-V in FIG. 3. Both cores 56 are implemented with a length 60, so that a first contact zone 72 results between the outside surfaces of cables 50 and 52 and first tool half 66 and a second contact zone 76 results on the diametrically opposed side between the outside surfaces of cables 50 and 52 and rounded core 56 of second tool half 68.

Upon injection of plastic material 70 into the closed cavity, both cables 50 and 52, which are situated plane-parallel to one another in the cavity, are accordingly secured on both sides against the prevailing injection pressure.

FIG. 6 shows an illustration along line VI-VI in FIG. 3.

The illustration according to FIG. 6 shows that lateral cores 64 are retracted into corresponding openings of first tool half 66. Lateral cores 64 are implemented in a cone shape 78 and have a planar front side 80, which plunges into recess 74 in second tool half 68—as shown in FIG. 6. Lateral cores 64 retracted into the cavity prevent cables 50 and 52 from floating laterally under the effect of the injection pressure and having their insulation sheath exposed to the metal transmission housing.

Alternatively to the illustration according to FIG. 6, lateral cores 64 may also be retracted from the bottom side, i.e., via accordingly configured openings in second tool half 68, into the cavity delimited by first tool half 66 and second tool half 68 and secure cables 50 and 52 against lateral floating.

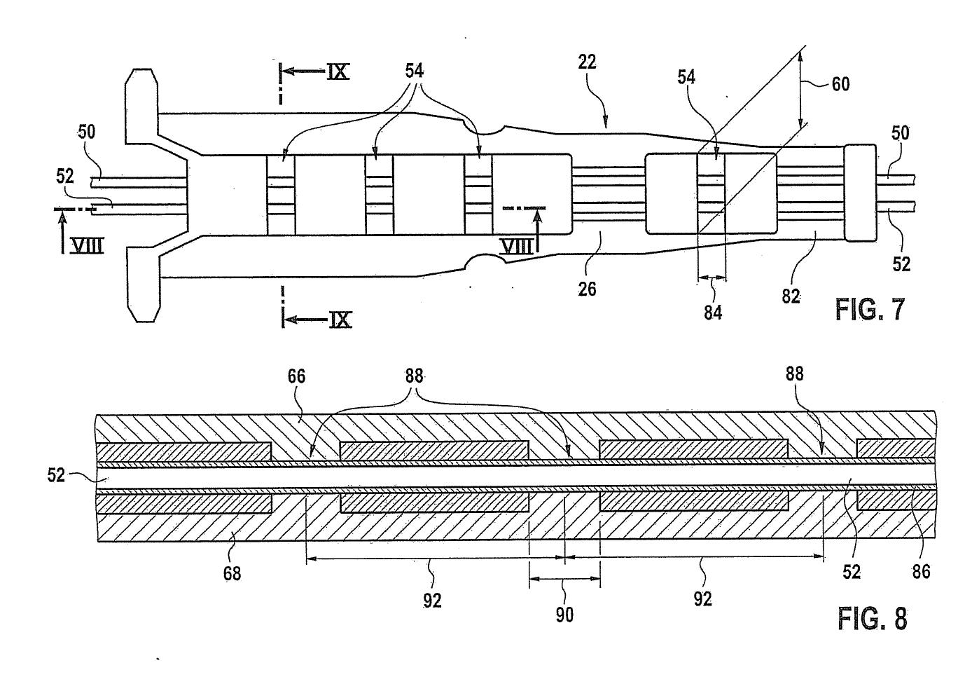

A further embodiment variant of the line set according to the present invention is depicted in the illustration according to FIG. 7. In this embodiment variant of line set 22, two cables 50 and 52 running plane-parallel to one another also extend through plastic body 104 with a length 106. In contrast to the top view of the first embodiment variant of line set 22 as shown in FIG. 3, support areas 54 are implemented in a second width 84 in the embodiment variant according to FIG. 7. The grid in which support areas 54 implemented by rounded cores 56 are implemented on the inner side of first tool half 66 and/or on the inner side of second tool half 68 corresponds to grid 62 of line set 22 according to the illustration in FIG. 3.

Because of second width 84, the radius of curvature of cores 56 representing support areas 54 may be selected as significantly larger, so that a gentler contact results between the outside surfaces of cables 50 and 52 to be embedded in plastic material 70 and tool halves 66 and 68 during the injection of plastic material 70 into the cavity of the injection-molding tool.

The illustration according to FIG. 8 corresponds to section line VIII-VIII in FIG. 7.

It is shown in this illustration that second cable 52, which is enclosed by an insulation sheath 86, is laid in the cavity between first tool half 66 and second tool half 68 and extrusion coated by plastic material 70. The grid, i.e., the sequence of individual windows 88 in which cores 56 are implemented on first tool half 66 and second tool half 68, is identified by reference numeral 92. A width of a window 88 is ideally in the magnitude of approximately 5 mm. Grid 92 in which individual windows 88 are spaced apart from one another is in the magnitude between 10 and 15 mm.

The sectional illustration of FIG. 8 shows that insulation sheath 86 of second cable 52 is held in the area of windows 88 on its top and bottom sides by cores 56 in first tool half 66 and second tool half 68. Because of grid 92, which is in the magnitude between 10 mm and 15 mm, it is ensured that at least one second cable 52 also maintains its clamping in the correct position according to the sectional illustration in FIG. 8 under consideration of the injection pressure in the cavity, i.e., in the closed state of first tool half 66 and second tool half 68. The tighter that grid 92 of windows 88, in which rounded tool cores 56 are implemented, is able to be kept, the greater the stability which may be achieved against the prevailing injection pressure in the cavity.

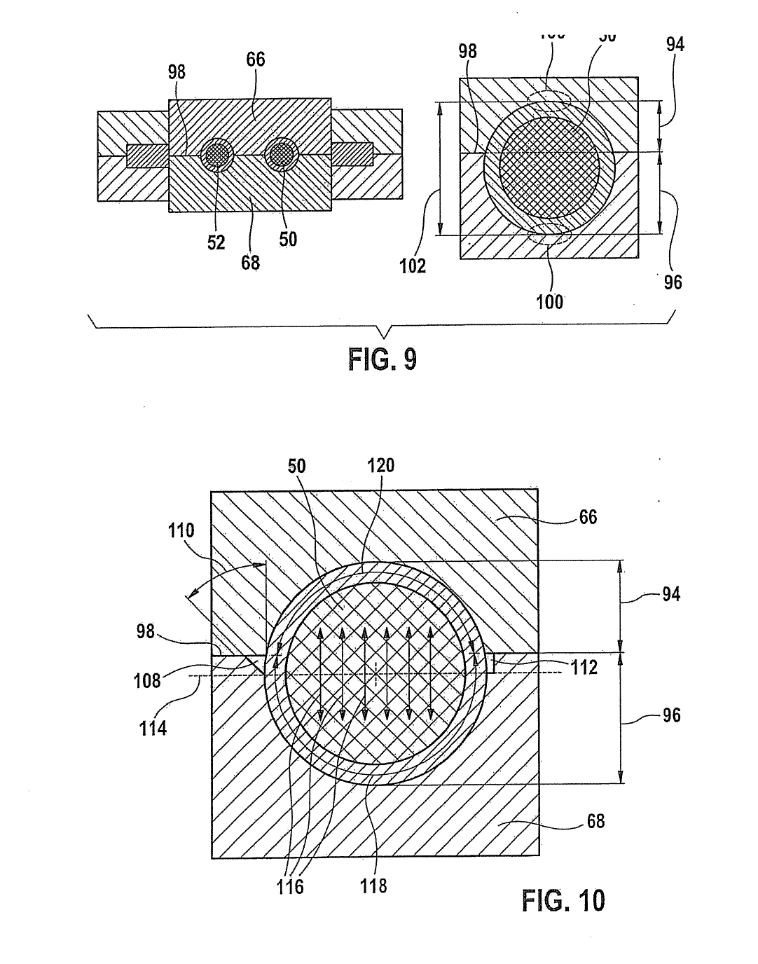

Finally, FIG. 9 shows section line IX-IX in FIG. 7.

The illustration of FIG. 9 shows that plastic body 104 completely encloses first cable 50 and second cable 52. First tool half 66 and second tool half 68 are situated along a tool partition 98 in the illustration shown in FIG. 9 (left image). Tool partition 98 lies centrally in the variant shown in FIG. 9 (left image). Rounded cores 56, which are specially shaped in the injection-molding tool, are preferably incorporated on both sides into the injection-molding tool and clamp cables 50 and 52 in the cavity of the injection-molding tool, i.e., the closed state of first tool half 66 and second tool half 68. Cables 50 and 52 are unrolled in a bent state during the manufacture of line sets 22 proposed according to the present invention according to both embodiment variants (FIGS. 3 and 7). The illustration of FIG. 9 (cf. right image) shows that first cable 50 shown therein has a cable diameter D, cf. reference numeral 102. First cable 50 shown in FIG. 9 (right image) is embedded in the plastic material. In the embodiment variant shown in FIG. 9 (right image), a tool partition 98 is off-center. Therefore, first cable 50 is embedded at a height ratio x:y in plastic material 70. FIG. 9 (right image) shows that a first height above tool partition 98 is x<½ D while second height 96 below tool partition 98 is y>½D.

Of course, as indicated in FIG. 9 (cf. left image), it is also possible to situate both cables 50 and 52, which are situated plane-parallel to one another in the cavity of the injection-molding tool, precisely in the plane of tool partition 98 in the cavity of the injection-molding tool.

Line set 22 proposed according to the present invention according to the embodiment variants in FIG. 3 and FIG. 7 is manufactured in such a way that first at least one cable 50 or 52 or also multiple cables are extrusion coated using a plastic material 70 to form a plastic body 104 in a cavity of an injection-molding tool 66, 68. During the forming of plastic body 104 in the closed cavity, at least one flexible, bendable area 26, 82 is produced, which acts as a film hinge and allows repeated removal of line set 22 proposed according to the present invention. During the injection of the plastic material into the cavity, i.e., during the extrusion coating of at least one cable 50 or 52 situated in the cavity, at least one contact zone 72, 76, or 88 is implemented via preferably rounded support areas situated on the sides of the tool halves pointing toward the cavity. The contact zone prevents a location change running generally in the horizontal direction of at least one cable 50 or 52 located in the cavity. The cables may thus withstand the injection pressure prevailing in the cavity of the plastic material, from which plastic body 106 is manufactured, and do not float in the lateral direction. In a refinement of the example method proposed according to the present invention for producing line sets 22, openings may be provided in one of the tool halves, into which the cores designed in the form of cones or cylinders retract, the front sides of the cores plunging into a recess 74, which may be implemented in lower, second tool half 68, for example.

Cables 50 and 52, which are subjected to the injection pressure in the cavity, are secured against lateral floating by lateral cores 64, which are retracted via suitable openings in one of tool halves 66 or 68. Using the approach according to the present invention, the location of the cables in the injection-molding tool may be secured under the injection pressure of plastic material 70 in the case of line set 22 and the method via which line set 22 is manufactured by plane-parallel embedding of cables 50 and 52 over entire length 106 of the line set cross section with the aid of corresponding openings in housing halves 66 and 68. Incorrect and damage-causing placing of cables 50 and 52 in the injection-molding tool is prevented. The reject rate may be reduced, on the one hand, during the pre-installation in the “park” position and, on the other hand, during the final installation of the line set with the control unit in the transmission, which is performed at the customer site. The example approach according to the present invention fulfills the vibration resistance requirements placed thereon, and no breaks occur during operation. As a result of the approach proposed according to the present invention, flexible and elastic film hinges 26 and 82 ensure that nondestructive removability is ensured, for example, in case of a repair, in spite of premature aging by being subjected to an aggressive medium, such as ATF.

FIG. 10 shows an embodiment variant of an off-center tool partition having recesses.

The illustration of FIG. 10 shows that, similarly to the illustration of FIG. 9, off-center tool partition 98 lies between first tool half 66 and second tool half 68. Off-center tool partition 98 is off-center in relation to a tool center, cf. reference numeral 114 in FIG. 10.

The illustration of FIG. 10 shows that first cable 50 having its larger outside circumference is already laid in second tool half 68, and is introduced therein at a first circular arc 118, which is slightly greater than 180°. First tool half 66 must only accommodate a smaller part of the outside circumference, indicated in FIG. 10, by second circular arc 120 (<180°) in its molded envelope when the divided tool moves together. When first and second tool halves 66, 68 move together, first cable 50 experiences compression 116 indicated by vertical arrows according to the illustration in FIG. 10. Compression 116 may be maintained without damage via laterally implemented recesses 108 and 112. While first recess 108 is implemented at an angle 110, second recess 112 is implemented as generally rectangular above tool center 114. Pinched cable areas of first cable 50 may leave slight marks on cable 50 via the elastic restoring capability of the flexible cable sheath. The cable insulation is not damaged by tool halves 66 and 68 in the case of the partition shown in FIG. 10 from first height 94 to second height 96, because no lasting damage is caused at the widest point of the cable diameter of first cable 50 by recesses 108 and 112, notwithstanding their geometry, in second tool half 68. First cable 50 is already secured via first circular arc 118 (>180°) in second tool half 68. Location inaccuracies of first cable 50 during the positioning in second tool half 68 are improved by securing ratio 94 to 96, because first tool half 66 secures>50% of the cable circumference of first cable 50 when tool halves 66, 68 move together. Location inaccuracies may originate, for example, because a prior curvature remains during the unwinding of the first cable from a coil or a drum and first cable 50 may not be inserted exactly plane-parallel.

What is claimed is:

1. A line set made of plastic material, comprising:
a plastic body having at least one flexible, elastic area; and
at least one cable for contacting a sensor, the at least one cable being embedded plane-parallel over its length in the plastic body.

2. The line set as recited in claim 1, wherein the at least one flexible, elastic area includes at least one film hinge in an area of maximum deformation.

3. The line set as recited in claim 1, wherein the at least one cable has an insulation sheath.

4. A method for manufacturing a line set, comprising:
a) extrusion coating at least one cable using a plastic material to form a plastic body in a cavity of an injection-molding tool;
b) producing at least one flexible, bendable area during the formation of the plastic body in step a); and
c) during step a), securing the at least one cable against location changes because of an effect of injection pressure via at least one support area while forming at least one contact zone in the injection-molding tool.

5. The method as recited in claim 4, wherein the at least one cable is secured during method step a) in the cavity by at least one horizontally running, rounded tool core.

6. The method as recited in claim 4, wherein the at least one cable is secured against horizontal shifting during the method step a) in the cavity by lateral cores.

7. The method as recited in claim 4, wherein the at least one cable is secured on both sides by horizontally running, rounded tool cores while forming at least one of a first contact zone and a second contact zone.

8. The method as recited in claim 4, wherein the at least one cable is secured in the cavity of the injection-molding tool by multiple tool cores, which are situated in a grid.

9. The method as recited in claim 4, wherein the at least one cable is clamped in the cavity in a height ratio x:y, where x<½ D and y>½D with D=cable diameter of the cable.

10. An injection-molding tool, comprising:
a first tool half and a second tool half, which together delimit a cavity;
wherein at least one of the tool halves includes rounded, horizontally running tool cores.

11. An injection-molding tool as recited in claim 10, wherein the cores have a width and a length.

12. The injection-molding tool as recited in claim 10, wherein one of the tool halves has openings for retracting contouring lateral cores into the cavity.

13. The injection-molding tool as recited in claim 10, wherein the tool cores are implemented in a grid on at least one of the tool halves delimiting the cavity.

14. The injection-molding tool as recited in claim 10, wherein a tool partition between a first tool half and a second tool half is off-center in relation to a tool center.

15. The injection-molding tool as recited in claim 14, wherein recesses are in the area of the off-center tool partition.

16. The injection-molding tool as recited in claim 15, wherein at least one of: i) a first one of the recesses is at an angle as a bevel, and ii) a second one of the recesses has one of a semicircular, rectangular, or square profile.
